(19) United States
(12) Patent Application Publication
(10) Pub. No.: US 2022/0287365 A1
(43) Pub. Date: Sep. 15, 2022

(54) CERAMIC CORE FOR VAPORIZATION DEVICE

(71) Applicant: HEXO OPERATIONS INC., Ottawa (CA)

(72) Inventors: MAX ALSAYAR, Ottawa (CA); PATRICK WOODS, Ottawa (CA); GUY DEGRACE, Ottawa (CA)

(21) Appl. No.: 17/637,496

(22) PCT Filed: Aug. 27, 2020
(86) PCT No.: PCT/CA2020/051171

§ 371 Date: Feb. 23, 2022

Related U.S. Application Data
(60) Provisional application No. 62/894,045, filed on Aug. 30, 2019.

(51) Int. Cl. A24F 40/46; A24F 40/44; A24F 40/10; H05B 3/18

(52) U.S. Cl. CPC A24F 40/46; A24F 40/44; A24F 40/10; H05B 3/18; H05B 2203/021

(57) ABSTRACT

Disclosed is a vaporization apparatus including a ceramic core having a characteristic, such as porosity, that enables a vaporization substance to seep through the ceramic core, and a heating element configured to heat the ceramic core and generate vapor by atomizing the vaporization substance that seeps through the ceramic core. According to an embodiment of the disclosure, the characteristic of the ceramic core is designed to be non-uniform, with a view to control, at least to some extent, how the vaporization substance seeps through the ceramic core. In this manner, it may be possible to mitigate leakage of the vaporization substance out of the vaporization apparatus.

### CROSS-REFERENCE TO RELATED APPLICATION

This application is related to, and claims priority to, U.S. Provisional Patent Application No. 62/894,045, entitled “CERAMIC CORE FOR VAPORIZATION DEVICE”, and filed on Aug. 30, 2019, the entire contents of which are incorporated by reference herein.

### FIELD OF THE DISCLOSURE

This application generally relates to vaporization apparatuses, and more particularly to vaporization apparatuses having ceramic cores.

### BACKGROUND

In a traditional wick-based vaporizer, an atomizer having a heating element heats a vaporization substance in a wick to atomize the vaporization substance. Heating of the vaporization substance in the wick is difficult to control, and some of the vaporization substance may be burned instead of being atomized, especially where the vaporization substance is in direct contact with the heating element. This can result in a burnt taste for a user.

In a ceramic core vaporizer, a heating element is typically embedded in a ceramic core. The ceramic core has a heat capacity and may take some time to heat up before being able to atomize the vaporization substance. However, the heat capacity of the ceramic core can enable the atomization of the vaporization substance to be better controlled, thereby avoiding the vaporization substance being burnt. This can result in better tasting vapor for the user.

A ceramic core vaporizer may provide vapor that is relatively pure and desirable compared to other vaporizers such as wick-based vaporizers, and hence ceramic core technology is an area of substantial interest. Unfortunately, it is possible for a vaporization substance to leak through the ceramic core of the ceramic core vaporizer. Such leakage can be messy and annoying for the user, and can affect operation of the ceramic core vaporizer.

### SUMMARY OF THE DISCLOSURE

Disclosed is a vaporization apparatus including a ceramic core having a characteristic that enables a vaporization substance to seep through the ceramic core in a non-uniform manner, and a heating element to heat the ceramic core and generate vapor from the vaporization substance, by atomizing the vaporization substance that seeps through the ceramic core.

According to an embodiment of the disclosure, the characteristic of the ceramic core is designed to be non-uniform, with a view to control, to some extent, how the vaporization substance seeps through the ceramic core. In this manner, it may be possible to mitigate leakage of the vaporization substance out of the vaporization apparatus.

In some implementations, the heating element is or includes a coil heater embedded in the ceramic core.

In some implementations, the vaporization apparatus further comprises a chamber coupled to the ceramic core to store the vaporization substance.

In some implementations, the chamber has a cylindrical shape that surrounds the ceramic core, and the ceramic core has a cylindrical shape that surrounds an air channel that enables the vapor to be drawn away from the ceramic core.

In some implementations, the vaporization apparatus comprises a wick disposed between the ceramic core and the chamber, to enable coupling between the ceramic core and the vaporization substance in the chamber.

In some implementations, the characteristic of the ceramic core comprises a physical characteristic of the ceramic core.

In some implementations, the physical characteristic of the ceramic core comprises a porosity of the ceramic core.

In some implementations, the porosity of the ceramic core varies along a path through which the vaporization substance is to seep through the ceramic core.

In some implementations, the ceramic core comprises a first ceramic layer and a second ceramic layer coupled to the first ceramic layer, to enable the vaporization substance to seep through the ceramic core via a series combination of the first ceramic layer and the second ceramic layer, and wherein a porosity of the first ceramic layer is different from a porosity of the second ceramic layer.

In some implementations, the porosity of the first ceramic layer is greater than the porosity of the second ceramic layer.

In some implementations, the heating element is embedded in the second ceramic layer of the ceramic core.

In some implementations, the heating element comprises a first heating element embedded in the first ceramic layer of the ceramic core, and a second heating element embedded in the second ceramic layer of the ceramic core.

In some implementations, the porosity of the ceramic core varies orthogonally to a path through which the vaporization substance is to seep through the ceramic core.

In some implementations, the ceramic core comprises a lower ceramic section and an upper ceramic section, to enable the vaporization substance to seep through the ceramic core via a parallel combination of the lower ceramic section and the upper ceramic section, and wherein a porosity of the upper ceramic section is different from a porosity of the lower ceramic section.

In some implementations, the porosity of the upper ceramic section is greater than the porosity of the lower ceramic section.

In some implementations, the heating element is embedded in both the lower ceramic section and the upper ceramic section of the ceramic core.

In some implementations, the heating element comprises a first heating element embedded in the lower ceramic section of the ceramic core, and a second heating element embedded in the upper ceramic section of the ceramic core.

In some implementations, the first heating element and the second heating element are embedded in different regions of the lower ceramic section of the ceramic core and the upper ceramic section of the ceramic core.

In some implementations, the porosity of the ceramic core varies along a path through which the vaporization substance is to seep through the ceramic core; and the porosity of the ceramic core varies orthogonally to the path through which the vaporization substance is to seep through the ceramic core.

In some implementations, the vaporization apparatus is a vaporization device and further comprises at least one of: a power source to provide power to the heating element, a control system to control the power source, and a mouthpiece to enable the vapor to be drawn from the ceramic core during use of the vaporization device.

Also disclosed is a method including supplying a vaporization substance to a ceramic core having a characteristic that enables the vaporization substance to seep through the ceramic core in a non-uniform manner, and heating the ceramic core using a heating element to generate vapor from the vaporization substance, by atomizing the vaporization substance that seeps through the ceramic core.

According to an embodiment of the disclosure, the characteristic of the ceramic core is designed to be non-uniform, with a view to control, to some extent, how the vaporization substance seeps through the ceramic core. In this manner, it may be possible to mitigate leakage of the vaporization substance out of the ceramic core.

In some implementations, the heating element is or includes a coil heater embedded in the ceramic core.

In some implementations, the method further comprises storing the vaporization substance.

In some implementations, the method further comprises enabling the vapor to be drawn away from the ceramic core.

In some implementations, supplying the vaporization substance to the ceramic core comprises supplying the vaporization substance to the ceramic core via a wick.

In some implementations, the characteristic of the ceramic core comprises a physical characteristic of the ceramic core.

In some implementations, the physical characteristic of the ceramic core comprises a porosity of the ceramic core.

In some implementations, the porosity of the ceramic core varies along a path through which the vaporization substance is to seep through the ceramic core.

In some implementations, the ceramic core comprises a first ceramic layer and a second ceramic layer coupled to the first ceramic layer, to enable the vaporization substance to seep through the ceramic core in the non-uniform manner via a series combination of the first ceramic layer and the second ceramic layer, and a porosity of the first ceramic layer is different from a porosity of the second ceramic layer.

In some implementations, the porosity of the first ceramic layer is greater than the porosity of the second ceramic layer.

In some implementations, the heating element is embedded in the second ceramic layer of the ceramic core.

In some implementations, the heating element comprises a first heating element embedded in the first ceramic layer of the ceramic core, and a second heating element embedded in the second ceramic layer of the ceramic core.

In some implementations, the porosity of the ceramic core varies orthogonally to a path through which the vaporization substance is to seep through the ceramic core.

In some implementations, the ceramic core comprises a lower ceramic section and an upper ceramic section, to enable the vaporization substance to seep through the ceramic core via a parallel combination of the lower ceramic section and the upper ceramic section, and a porosity of the upper ceramic section is different from a porosity of the lower ceramic section.

In some implementations, the porosity of the upper ceramic section is greater than the porosity of the lower ceramic section.

In some implementations, the heating element is embedded in both the lower ceramic section and the upper ceramic section of the ceramic core.

In some implementations, the heating element comprises a first heating element embedded in the lower ceramic section of the ceramic core, and a second heating element embedded in the upper ceramic section of the ceramic core.

In some implementations, the first heating element and the second heating element are embedded in different regions of the lower ceramic section of the ceramic core and the upper ceramic section of the ceramic core.

In some implementations, the porosity of the ceramic core varies along a path through which the vaporization substance is to seep through the ceramic core; and the porosity of the ceramic core varies orthogonally to the path through which the vaporization substance is to seep through the ceramic core.

In some implementations, the method further comprises controlling power provided to the heating element.

Also disclosed is a kit of parts including a ceramic core having a characteristic to enable a vaporization substance to seep through the ceramic core in a non-uniform manner, and a heating element to heat the ceramic core and generate vapor from the vaporization substance, by atomizing the vaporization substance that seeps through the ceramic core.

According to an embodiment of the disclosure, the characteristic of the ceramic core is designed to be non-uniform, with a view to control, to some extent, how the vaporization substance seeps through the ceramic core. In this manner, it may be possible to mitigate leakage of the vaporization substance out of the ceramic core.

In some implementations, the heating element is or includes a coil heater embedded in the ceramic core.

In some implementations, the kit of parts comprises a chamber to store the vaporization substance.

In some implementations, the chamber has a cylindrical shape that surrounds the ceramic core, and the ceramic core has a cylindrical shape that surrounds an air channel that enables the vapor to be drawn away from the ceramic core.

In some implementations, the kit of parts comprises a wick to be disposed between the ceramic core and the chamber, to enable coupling between the ceramic core and the vaporization substance in the chamber.

In some implementations, the kit of parts comprises the vaporization substance.

In some implementations, the characteristic of the ceramic core comprises a physical characteristic of the ceramic core.

In some implementations, the physical characteristic of the ceramic core comprises a porosity of the ceramic core.

In some implementations, the porosity of the ceramic core varies along a path through which the vaporization substance is to seep through the ceramic core.

In some implementations, the ceramic core comprises a first ceramic layer and a second ceramic layer coupled to the first ceramic layer, to enable the vaporization substance to seep through the ceramic core via a series combination of the first ceramic layer and the second ceramic layer, and wherein a porosity of the first ceramic layer is different from a porosity of the second ceramic layer.

In some implementations, the porosity of the first ceramic layer is greater than the porosity of the second ceramic layer.

In some implementations, the heating element is embedded in the second ceramic layer of the ceramic core.

In some implementations, the heating element comprises a first heating element embedded in the first ceramic layer of the ceramic core, and a second heating element embedded in the second ceramic layer of the ceramic core.

In some implementations, the porosity of the ceramic core varies orthogonally to a path through which the vaporization substance is to seep through the ceramic core.

In some implementations, the ceramic core comprises a lower ceramic section and an upper ceramic section, to enable the vaporization substance to seep through the ceramic core via a parallel combination of the lower ceramic section and the upper ceramic section, and wherein a porosity of the upper ceramic section is different from a porosity of the lower ceramic section.

In some implementations, the porosity of the upper ceramic section is greater than the porosity of the lower ceramic section.

In some implementations, the heating element is embedded in both the lower ceramic section and the upper ceramic section of the ceramic core.

In some implementations, the heating element comprises a first heating element embedded in the lower ceramic section of the ceramic core, and a second heating element embedded in the upper ceramic section of the ceramic core.

In some implementations, the first heating element and the second heating element are embedded in different regions of the lower ceramic section of the ceramic core and the upper ceramic section of the ceramic core.

In some implementations, the porosity of the ceramic core varies along a path through which the vaporization substance is to seep through the ceramic core; and the porosity of the ceramic core varies orthogonally to the path through which the vaporization substance is to seep through the ceramic core.

In some implementations, the kit of parts comprises at least one of a power source to provide power to the heating element, a control system to control the power source, and a mouthpiece to enable the vapor to be drawn from the ceramic core.

Also disclosed is a method including providing a ceramic core having a characteristic that enables a vaporization substance to seep through the ceramic core in a non-uniform manner, and providing a heating element to heat the ceramic core and generate vapor from the vaporization substance, by atomizing the vaporization substance that seeps through the ceramic core.

According to an embodiment of the disclosure, the characteristic of the ceramic core is designed to be non-uniform, with a view to control, to some extent, how the vaporization substance seeps through the ceramic core. In this manner, it may be possible to mitigate leakage of the vaporization substance out of the ceramic core.

In some implementations, the heating element is or includes a coil heater embedded in the ceramic core.

In some implementations, the method comprises providing an air channel to enable the vapor to be drawn away from the ceramic core.

In some implementations, the method comprises providing a chamber to store the vaporization substance.

In some implementations, the chamber has a cylindrical shape that surrounds the ceramic core, and the ceramic core has a cylindrical shape that surrounds an air channel that enables the vapor to be drawn away from the ceramic core.

In some implementations, the method comprises providing a wick between the ceramic core and the chamber, to enable coupling between the ceramic core and the vaporization substance in the chamber.

In some implementations, the characteristic of the ceramic core comprises a physical characteristic of the ceramic core.

In some implementations, the physical characteristic of the ceramic core comprises a porosity of the ceramic core.

In some implementations, the porosity of the ceramic core varies along a path through which the vaporization substance is to seep through the ceramic core.

In some implementations, the ceramic core comprises a first ceramic layer and a second ceramic layer coupled to the first ceramic layer, to enable the vaporization substance to seep through the ceramic core via a series combination of the first ceramic layer and the second ceramic layer, and wherein a porosity of the first ceramic layer is different from a porosity of the second ceramic layer.

In some implementations, the porosity of the first ceramic layer is greater than the porosity of the second ceramic layer.

In some implementations, the heating element is embedded in the second ceramic layer of the ceramic core.

In some implementations, the heating element comprises a first heating element embedded in the first ceramic layer of the ceramic core, and a second heating element embedded in the second ceramic layer of the ceramic core.

In some implementations, the porosity of the ceramic core varies orthogonally to a path through which the vaporization substance is to seep through the ceramic core.

In some implementations, the ceramic core comprises a lower ceramic section and an upper ceramic section, to enable the vaporization substance seeps through the ceramic core via a parallel combination of the lower ceramic section and the upper ceramic section, and wherein a porosity of the upper ceramic section is different from a porosity of the lower ceramic section.

In some implementations, the porosity of the upper ceramic section is greater than the porosity of the lower ceramic section.

In some implementations, the heating element is embedded in both the lower ceramic section and the upper ceramic section of the ceramic core.

In some implementations, the heating element comprises a first heating element embedded in the lower ceramic section of the ceramic core, and a second heating element embedded in the upper ceramic section of the ceramic core.

In some implementations, the first heating element and the second heating element are embedded in different regions of the lower ceramic section of the ceramic core and the upper ceramic section of the ceramic core.

In some implementations, the porosity of the ceramic core varies along a path through which the vaporization substance is to seep through the ceramic core; and the porosity of the ceramic core varies orthogonally to the path through which the vaporization substance is to seep through the ceramic core.

In some implementations, the method comprises providing at least one of a power source to provide power to the heating element, a control system to control the power source, and a mouthpiece to enable the vapor to be drawn from the ceramic core.

Also disclosed is a method including generating vapor using a vaporization device having a vaporization apparatus as described herein, and inhaling the vapor.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a diagram illustrating an example vaporization device having a vape tank;

FIG. 2 is a diagram illustrating an example vape tank with a ceramic core;

FIGS. 3A and 3B are diagrams illustrating example ceramic cores having non-uniform porosity;

FIGS. 4A and 4B are diagrams illustrating other example ceramic cores having non-uniform porosity;

FIG. 5 is a flowchart of an example method of generating vapor for consumption by a user;

FIG. 6 is a flowchart of an example method according to another embodiment;

FIG. 7 is a flowchart of an example method of using a vaporization device; and

FIG. 8 is a diagram illustrating another example vape tank with a ceramic core.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

### Introduction

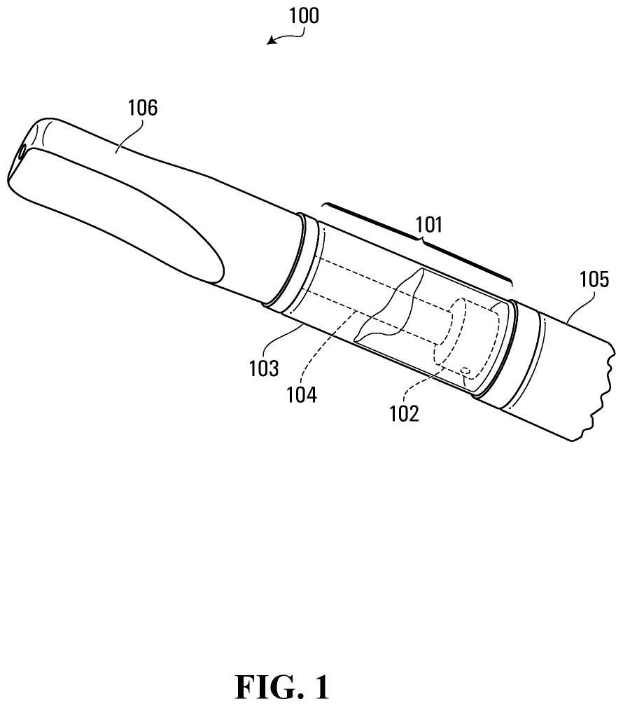

Referring first to FIG. 1, shown is a diagram illustrating an example vaporization device 100 having a vape tank 101. The vape tank 101 has a ceramic core 102 coupled to a chamber 103 that stores a vaporization substance. The vape tank 101 is powered by a power source such as a battery, inside a compartment 105, that physically and electrically connects to the vape tank 101. In some implementations, the vaporization device 100 has a control system (not shown) to control how the power source provides power to the vape tank 101.

During use, the vaporization substance from the chamber 103 seeps into the ceramic core 102, which heats the vaporization substance using a heating element (not shown) enough to atomize the vaporization substance thereby producing vapor. The vapor can be drawn out of and away from the ceramic core 102 through a stem 104 and out of the vaporization device 100 through a mouthpiece 106.

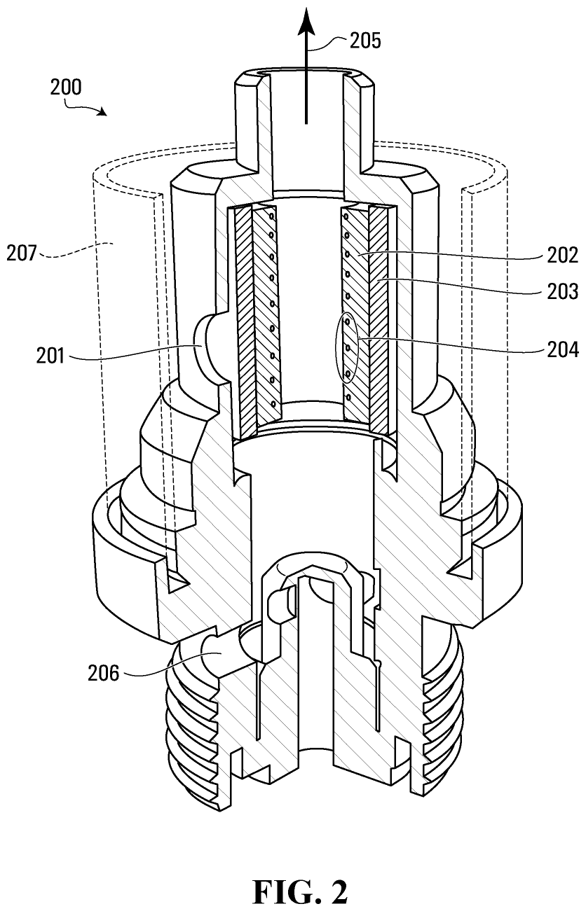

Referring now to FIG. 2, shown is a diagram illustrating an example vape tank 200 with a ceramic core 202. The vape tank 200 is shown with a section removed so that internals of the vape tank 200 can be seen. The vape tank 200 can be implemented in a vaporization device, for example the vaporization device 100 shown in FIG. 1, or any other suitable vaporization device. It is to be understood that the vape tank 200 is very specific and is provided for illustrative purposes only.

In some implementations, as shown in the illustrated example, the vape tank 200 has an inlet 201 for receiving a vaporization substance from a chamber 207. In other implementations, there is no such inlet 201 or chamber 207, and the vaporization substance is supplied to the ceramic core 202 by other means such as manual application by a user for example. The ceramic core 202 has a heating element 204 embedded therein and a characteristic, such as density or porosity in some embodiments, that enables the vaporization substance to seep through the ceramic core 202, particularly when the vaporization substance has been heated enough by the heating element 204 to reduce its viscosity.

In some implementations, the vape tank 200 has a wick 203 disposed between the chamber 207 and the ceramic core 202. In some implementations, the wick 203 is made from cotton or any other suitable material that has a lower porosity than the ceramic core 202. In some implementations, the porosity of the wick 203 is high enough so the vaporization substance can easily seep through the wick and make contact with the ceramic core 202 even without any heating from the heating element 204 embedded in the ceramic core 202. The wick 203 may help to ensure an even contact between the vaporization substance and the ceramic core 202. In other implementations, the vape tank 200 has no such wick 203.

During use, the heating element 204 heats up the ceramic core 202 and generates vapor from the vaporization substance by atomizing the vaporization substance that seeps through the ceramic core 202. The vapor can be drawn through an air channel as shown at 205, and an air inlet 206 is disposed beneath the ceramic core 202 to facilitate airflow 205 for the air channel through the ceramic core. In some implementations, the heating element 204 is powered by a power source (not shown) and controlled by a control system (not shown). In some implementations, the power source and the control system are disposed in a compartment that physically and electrically connects to the vape tank 200. Such connections include electrical connections (not shown) between the heating element 204 and the power source and/or the control system.

According to an embodiment of the present disclosure, the characteristic of the ceramic core 202 is designed to be non-uniform, with a view to control, to some extent, how the vaporization substance seeps through the ceramic core 202. In this manner, it may be possible to mitigate leakage of the vaporization substance out of the vape tank 200. Note that leakage can be messy and annoying for a user, and hence mitigating such leakage is desirable.

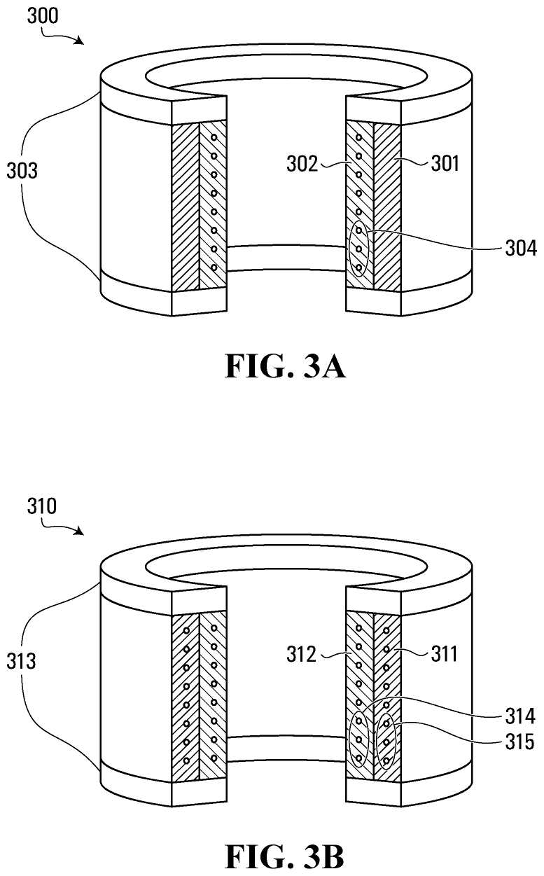

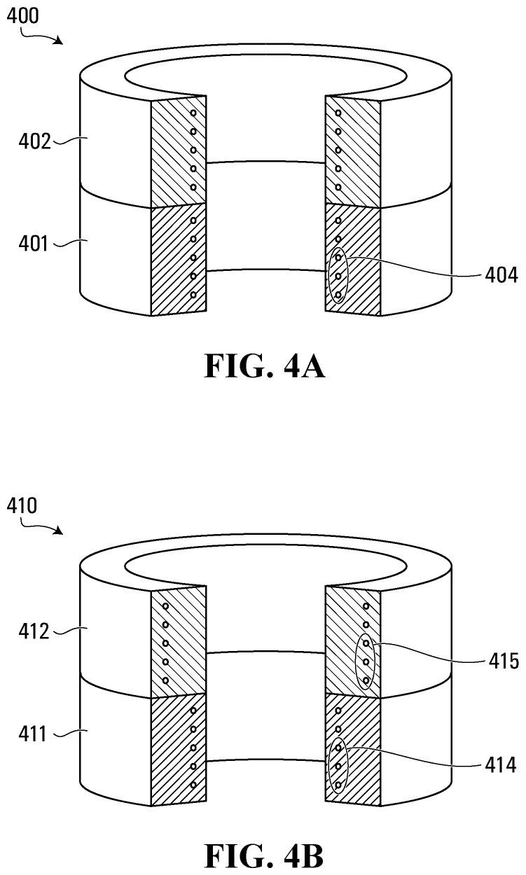

There are many ways in which the characteristic of the ceramic core 202 can be designed to be non-uniform to mitigate leakage. Example implementations are described with reference to FIGS. 3A, 3B, 4A and 4B, for a specific case of porosity being the characteristic. However, it is to be understood that other implementations are possible, in which density or another characteristic instead of or in addition to porosity is considered. Also, while the present disclosure focuses on physical characteristics such as porosity or density for example, it is noted that other implementations are possible. For example, in another embodiment, a chemical characteristic of the ceramic core 202 can be designed to be non-uniform to mitigate leakage. More generally, any suitable characteristic of the ceramic core 202 can be designed to be non-uniform to mitigate leakage.

A characteristic of a ceramic core that is “non-uniform” as described herein refers to any characteristic, including a physical characteristic such as porosity and/or density, or a chemical characteristic, of the ceramic core designed to vary within the ceramic core. For example, a first ceramic portion such as a layer or section of the ceramic core is designed, via composition and/or manufacturing technique for example, to differ from a second ceramic portion such as a layer or section of the ceramic core in terms of a characteristic such as porosity or density. In this way, the difference in the characteristic is by design and not naturally occurring.

The characteristic of a ceramic core that is non-uniform causes a vaporization substance to seep through the ceramic core in a non-uniform manner. Seeping involves a slow flow or leak through porous material or small holes, and/or passing slowly through and/or penetrating through. In the case of a first ceramic portion being designed to differ from a second ceramic portion in terms of a characteristic such as porosity or density, the seeping through the first ceramic portion is not the same as the seeping through the second ceramic portion. For example, a flow of the vaporization substance seeping through the first ceramic portion may be faster or slower than a flow of the vaporization substance seeping through the second ceramic portion.

In some implementations, the heating element 204 is or includes a coil heater with a number of coil turns or loops embedded in the ceramic core 202. Three of these coil turns or loops are identified by an oval in the illustrated example, but more coil turns or loops can be seen in the illustrated example. Note that the number of coil turns or loops is implementation-specific. In some implementations, the coil heater is embedded in the ceramic core 202 during manufacture of the ceramic core 202. The ceramic core 202 has a heat capacity, and thus embedding the coil turns or loops in the ceramic core 202 can help to avoid a situation in which the coil turns or loops become too hot and burn the vaporization substance. Although the present disclosure focuses on coil heaters, it is noted that other heating elements are possible and are within the scope of this disclosure.

In some implementations, the heating element 204 is embedded closer to an inside portion of the ceramic core 202 as shown, such that the vaporization substance may reach higher temperatures as it seeps through the ceramic core 202 towards the central air channel that goes through the ceramic core 202. When the vaporization substance seeping through the ceramic core 202 is heated enough, it atomizes to produce a vapor which can be drawn out through the air channel. In other implementations, the heating element 204 is embedded in a middle portion of the ceramic core 202. In other implementations, the heating element 204 is not embedded in the ceramic core 202 and is instead positioned inside of the ceramic core 202 by the air channel.

The temperature at which the vaporization substance is atomized to produce the vapor may depend on any one or more of a number of factors such as the vaporization substance being used, and a thermal conductivity of the ceramic core 202 and the vaporization substance itself. As a specific example, the temperature at which the vaporization substance is atomized may be around 300° F. or higher. In a specific example, the temperature of the vaporization substance should not exceed 600° F. or else it may burn. Specific example temperatures that may result based on wattages are shown in the left column of Table 1 below.

TABLE 1
Example Temperatures

| | | | improper | |
|---|---|---|---|---|
| 1 g | 2.5 g | 5 g | temperature ranges | (100-250° C.). |
| T (° C.) | CHU IT | CHU IT | KJ | watt |
| 584.400 | 9.740 | 19.4800 | 37.4026 | 24 |
| 534.312 | 8.905 | 17.8104 | 34.2857 | 22 |
| 485.748 | 8.096 | 16.1916 | 31.1688 | 20 |
| 461.461 | 7.691 | 15.3820 | 29.6104 | 19 |
| 437.173 | 7.286 | 14.5724 | 28.0519 | 18 |
| 388.598 | 6.477 | 12.9533 | 24.9351 | 16 |
| 361.500 | 6.025 | 12.0500 | 23.37662338 | 15 |
| 340.024 | 5.667 | 11.3341 | 21.81818182 | 14 |
| 291.449 | 4.857 | 9.7150 | 18.7012987 | 12 |
| 242.874 | 4.048 | 8.0958 | 15.58441558 | 10 |
| 218.587 | 3.643 | 7.2862 | 14.02597403 | 9 |
| 194.299 | 3.238 | 6.4766 | 12.46753247 | 8 |

In Table 1, “1 g”, “2.5 g”, and “5 g” indicate weight of a vaporization substance, and “CHU IT” is specific heat.

In some implementations, a control system (not shown) is configured to ensure suitable temperatures during use by controlling power delivery to the heating element 204 from a power source (not shown). For example, in some implementations, the control system powers the heating element 204 when a user takes a pull to effect the vaporization of the vaporization substance that seeps through the ceramic core 202. If the temperature is too low, then the vaporization substance may not vaporize, and leakage could occur. If the temperature is too high, then the vaporization substance may be burned, which can cause poor tasting vapor for the user.

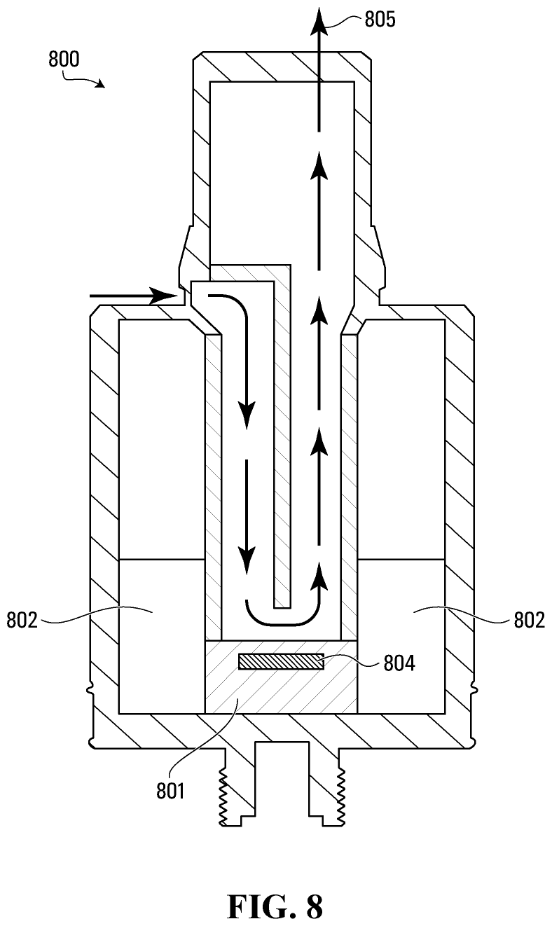

In some implementations, as shown in the illustrated example, the vape tank 200 has a cylindrical shape with the air channel being substantially linear through the ceramic core 202. For instance, the ceramic core 202 has a cylindrical shape that surrounds the air channel, and the chamber 207 has a cylindrical shape that surrounds the ceramic core 202. However, it is to be understood that other geometries are possible and are within the scope of the disclosure. Any suitable geometry can be implemented such that a ceramic core is coupled to a chamber and generates vapor for an air channel which can be linear or non-linear. To illustrate this point, another example vape tank with different geometries will be described later with reference to FIG. 8.

### Ceramic Core

With reference to FIGS. 3A, 3B, 4A and 4B, example ceramic cores are described below for a specific case of porosity being the characteristic. However, as noted elsewhere herein, other implementations are possible in which density and/or another characteristic besides or in addition to porosity can be considered.

Referring first to FIG. 3A, shown is a diagram illustrating an example ceramic core 300 having non-uniform porosity. The ceramic core 300 is shown with a section removed so that internals of the ceramic core 300 can be seen. The ceramic core 300 can be implemented in vape tank of a vaporization device, for example the vape tank 200 shown in FIG. 2, or any other suitable vape tank. The ceramic core 300 has non-uniform porosity by employing a first ceramic layer 301 and a second ceramic layer 302 that is coupled to the first ceramic layer, with the porosity of the first ceramic layer 301 being greater than the porosity of the second ceramic layer 302, for example. The ceramic core 300 has a heating element 304 embedded therein in FIG. 3A.

During use, a vaporization substance, for example from a chamber (not shown), seeps through the ceramic core 300 via a series combination of the first ceramic layer 301 and the second ceramic layer 302, particularly when the vaporization substance has been heated enough by the heating element 304 to reduce its viscosity. Vapor is generated by atomizing the vaporization substance that seeps through the ceramic core 300. The vapor can then be inhaled by a user.

In an example above, the porosity of the first ceramic layer 301 is greater than the porosity of the second ceramic layer 302. As a result, the vaporization substance will seep through the first ceramic layer 301 relatively easily, which may ensure adequate flow of the vaporization substance to the second ceramic layer 302. Meanwhile, the flow of the vaporization substance is limited by the second ceramic layer 302, which may avoid a situation in which too much vaporization substance seeps through the ceramic core 300 and causes leakage. Thus, the non-uniform porosity of the ceramic core 300 may mitigate leakage of the vaporization substance.

The porosity of the first ceramic layer 301 and the second ceramic layer 302 may depend on any one or more of a number of factors such as types of minerals used and particle sizes. In some implementations, the ceramic core 300 is manufactured as a uniform piece with different porosity layers, examples of which are described below. Alternatively, the first ceramic layer 301 and the second ceramic layer 302 are manufactured as separate pieces that are bonded together, for example using connecting blocks 303. The connecting blocks 303 can be formed of any suitable material that is generally not porous so that the vaporization substance will not seep through the connecting blocks 303, or at least not pass through the connecting blocks 303 to the same extent as through the ceramic layers 301, 302.

An example approach for creating multi-layered ceramic using different powders/materials and compacting and firing them is disclosed in Faheemuddin Patel, Mirza Ageel Baig & Tahar Laoui (2011) Processing of porous alumina substrate for multilayered ceramic filter, Desalination and Water Treatment, 35:1-3, 33-38, DOI: 10.5004/dwt.2011.3505. As another example, an approach of using a binder between two ceramics, compacting them, and firing them together with the binder to create a uniform piece of ceramic is disclosed in U.S. Pat. No. 4,629,483. Another example of creating a ceramic porosity gradient using different starch types is disclosed in Gregorová, E & Zivcova, Zuzana & Pabst, W & Kunertová, A. (2019). Starch-Processed Ceramics with Porosity or Pore Size Gradients. Similar approaches to those described in these referenced documents can be employed to achieve the non-uniform porosity for the ceramic core 300. Other embodiments are also possible.

Many ceramics include a combination of ingredients, for example water, resin and other binders. Many ceramics also include a combination of oxides and/or nitrides such as those formed by compounds of aluminum, lead, silicon, boron, magnesium, and titanium for example. Some notable examples include aluminium oxide, silicon nitride, beryllium oxide, and aluminum nitride. In some applications, these compounds may be combined with oxides of nickel manganese, cobalt, and/or iron. Silica may also be used in microporous ceramics. In some implementations, the first ceramic layer 301 and the second ceramic layer 302 are formed of different combinations of ingredients to achieve different characteristics such as porosity or density.

Although the porosity of the first ceramic layer 301 is greater than the porosity of the second ceramic layer 302 in an example above, it is noted that other implementations are possible in which the porosity of the first ceramic layer 301 is less than the porosity of the second ceramic layer 302. More generally, implementations are possible in which the porosity of the first ceramic layer 301 is different from the porosity of the second ceramic layer 302.

In some implementations, the porosity within each layer is substantially uniform. For example, in a specific implementation, the first ceramic layer 301 has a uniform porosity of about 40% while the second ceramic layer 302 has a uniform porosity of about 20%; in another specific implementation, the first ceramic layer 301 has a uniform porosity of about 25% while the second ceramic layer 302 has a uniform porosity of about 15%. In other implementations, the porosity within each layer is not uniform and instead varies.

Although the ceramic core 300 is shown to have two layers, more generally any number of layers can be implemented. The number of layers is implementation specific. A boundary between two adjacent layers is generally where porosity increases or decreases from one layer to another layer, and this is a result of manufacturing. Note that multiple layers are not necessary, as a single layer with varying porosity can be employed. For instance, in other implementations, a ceramic core has a porosity that continuously increases or decreases from one end to another end, with porosity decreasing continuously from about 40% to about 20%, or decreasing continuously from about 25% to about 15% for example. More generally, implementations are possible in which porosity varies along a path or direction through which the vaporization substance is to seep through the ceramic core. This path or direction is the inward radial direction in FIG. 3A, for example.

In some implementations, the heating element 304 is or includes a coil heater with a number of coil turns or loops embedded in the ceramic core 300. Three of these coil turns or loops are identified by an oval in the illustrated example, but more coil turns or loops can be seen in the illustrated example. Note that the number of coil turns or loops is implementation-specific. Other implementations are possible as similarly described for the heating element 204 shown in FIG. 2.

In some implementations, the heating element 304 is embedded in the second ceramic layer 302 as shown. In this way, the vaporization substance seeping through the ceramic core 300 may be heated to a higher temperature by the second ceramic layer 302 compared to the first ceramic layer 301. A result is that the viscosity of the vaporization substance can decrease as it seeps from the first ceramic layer 301 to the second ceramic layer 302 during use. By having a relatively low porosity in the second ceramic layer 302 compared to first ceramic layer 301, the ceramic core 300 can provide seeping resistance to the vaporization substance in a manner that is commensurate with the viscosity of the vaporization substance. In other implementations, the heating element 304 is embedded in the first ceramic layer 301.

With reference to FIG. 3B, shown is a diagram illustrating another example ceramic core 310 having non-uniform porosity. Much like the ceramic core 300 of FIG. 3A, the ceramic core 310 of FIG. 3B has non-uniform porosity by employing a first ceramic layer 311 and a second ceramic layer 312, such that the porosity of the first ceramic layer 311 is different from the porosity of the second ceramic layer 312, and in some implementations the first ceramic layer 311 and the second ceramic layer 312 are bonded together using connecting blocks 313. However, unlike the ceramic core 300 of FIG. 3A, each of the ceramic layers 311, 312 of the ceramic core 310 of FIG. 3B has a heating element 314, 315 embedded therein. In some implementations, the heating elements 314, 315 achieve different levels of heating, for example by having different configurations such as different impedances and/or having different power applied. As an example of operation, the first ceramic layer 311 is heated to a relatively low temperature to heat the vaporization substance and to help it absorb or flow into the ceramic core 310, while the second ceramic layer 312 is heated to a relatively high temperature to atomize the vaporization substance. In some implementations, the heating elements 314, 315 are or include coil heaters, but other implementations are possible as similarly described for the heating element 204 shown in FIG. 2.

Referring now to FIG. 4A, shown is a diagram illustrating another example ceramic core 400 having non-uniform porosity. The ceramic core 400 is shown with a section removed so that internals of the ceramic core 400 can be seen. The ceramic core 400 can be implemented in a vape tank of a vaporization device, for example the vape tank 200 shown in FIG. 2, or any other suitable vape tank. The ceramic core 400 has non-uniform porosity by employing a lower ceramic section 401 and an upper ceramic section 402, with the porosity of the upper ceramic section 402 being greater than the porosity of the lower ceramic section 401 in an embodiment. The ceramic core 400 has a heating element 404 embedded therein.

During use, a vaporization substance, for example from a chamber (not shown), seeps through the ceramic core 400 via a parallel combination of the lower ceramic section 401 and the upper ceramic section 402, particularly when the vaporization substance has been heated enough by the heating element 404 to reduce its viscosity. Vapor is generated by atomizing the vaporization substance seeping through the ceramic core 400. The vapor can then be inhaled by a user.

As noted above, the porosity of the upper ceramic section 402 is greater than the porosity of the lower ceramic section 401. This can enable more vaporization substance to seep through the porous core 400 through the upper ceramic section 402 compared to the lower ceramic section 401 during use, which could mitigate leakage out of the lower ceramic section 401 when the ceramic core 400 is in an upright position in which the ceramic core 400 is oriented as shown in FIG. 4A. While it is possible for excess vaporization substance to seep through the upper ceramic section 402, such vaporization substance would have a relatively longer distance to travel down the lower ceramic section 401 if the ceramic core 400 is in an upright position, which may prevent the vaporization substance from leaking out of the ceramic core 400. Thus, the non-uniform porosity of the ceramic core 400 may mitigate leakage of the vaporization substance.

The porosity of the lower ceramic section 401 and the upper ceramic section 402 may depend on any one or more of a number of factors such as types of minerals used and particle sizes. In some implementations, the ceramic core 400 is manufactured as a uniform piece with different porosity sections, as similarly described for the ceramic core 300 shown in FIG. 3A. In such implementations, the heating element 404 can be a uniform piece that extends through both the lower ceramic section 401 and the upper ceramic section 402. Alternatively, the lower ceramic section 401 and the upper ceramic section 402 are separate pieces that are bonded together. In such implementations, the heating element 404 can include a first heating element embedded in the lower ceramic section 401 and a second heating element embedded in the upper ceramic section 402.

Although the porosity of the upper ceramic section 402 is greater than the porosity of the lower ceramic section 401 in an example above, it is noted that other implementations are possible in which the porosity of the upper ceramic section 402 is less than the porosity of the lower ceramic section 401. More generally, implementations are possible in which the porosity of the upper ceramic section 402 is different from the porosity of the lower ceramic section 401.

In some implementations, the porosity within each section is substantially uniform. For example, in a specific implementation, the upper ceramic section 402 has a uniform porosity of about 40% while the lower ceramic section 401 has a uniform porosity of about 20%; in another specific implementation, the upper ceramic section 402 has a uniform porosity of about 25% while the lower ceramic section 401 has a uniform porosity of about 15%. In other implementations, the porosity within each section is not uniform and instead varies.

Although the ceramic core 400 is shown to have two sections, more generally any number of sections can be implemented. The number of sections is implementation specific. The boundary between two adjacent sections is generally where porosity increases or decreases from one section to another section, and this is a result of manufacturing. Note that multiple sections are not necessary, as a single section with varying porosity can be employed. For instance, in other implementations, a ceramic core has a porosity that continuously increases or decreases from one end to another end, with porosity decreasing continuously from about 40% to about 20%, or decreasing continuously from about 25% to about 15%, for example. More generally, implementations are possible in which the porosity of the ceramic core varies orthogonally to a path through which the vaporization substance is to seep through the ceramic core. The path in FIG. 4A is in the radial direction, and the porosity of the ceramic core varies in the axial direction, which is orthogonal to the path in this example.

In some implementations, the heating element 404 is or includes a coil heater with a number of coil turns or loops embedded in the ceramic core 400. Three of these coil turns or loops are identified by an oval in the illustrated example, but more coil turns or loops can be seen in the illustrated example. Note that the number of coil turns or loops is implementation-specific. Other implementations are possible as similarly described for the heating element 204 shown in FIG. 2.

In some implementations, the heating element 404 is embedded in a region closer to an inside portion of the ceramic core 400 as shown and as similarly described for the ceramic core 300 shown in FIG. 3A. In other implementations, the heating element 404 is embedded in a region closer to an outside portion of the ceramic core 400.

With reference to FIG. 4B, shown is a diagram illustrating another example ceramic core 410 having non-uniform porosity. Much like the ceramic core 400 of FIG. 4A, the ceramic core 410 of FIG. 4B has non-uniform porosity by employing a lower ceramic section 411 and an upper ceramic section 412, with the porosity of the upper ceramic section 412 being different from the porosity of the lower ceramic section 411. However, unlike the ceramic core 400 of FIG. 4A, heating elements 414, 415 of the ceramic core 410 of FIG. 4B are embedded in different regions of the ceramic sections 411, 412. In some implementations, the heating elements 414, 415 achieve different levels of heating by virtue of the different regions. As an example of operation, the upper ceramic section 412 is heated to a relatively low temperature to heat the vaporization substance and to help it absorb or flow into the ceramic core 410, while the lower ceramic section 411 is heated to a relatively high temperature, particularly near an inside region, to atomize the vaporization substance. In some implementations, the heating elements 414, 415 are coil heaters, but other implementations are possible as similarly described for the heating element 204 shown in FIG. 2.

It is to be understood that the ceramic cores 300, 310 shown in FIGS. 3A and 3B and the ceramic cores 400, 410 shown in FIGS. 4A and 4B are specific implementations and that other implementations are possible. For instance, different geometries are possible for different vape tanks with different geometries. Also, various combinations of layers and sections throughout a ceramic core are possible to achieve more complex non-uniformity of porosity than that shown in FIGS. 3A, 3B, 4A and 4B. In such implementations, it is possible for the porosity of a ceramic core to vary both (1) along a path through which the vaporization substance is to seep through the ceramic core, and (2) orthogonally to the path through which the vaporization substance is to seep through the ceramic core. Note that such complex non-uniformity of porosity can also be achieved without layers or sections, by instead implementing a single ceramic piece with varying porosity. Other implementations are possible.

### Methods of Generating Vapor

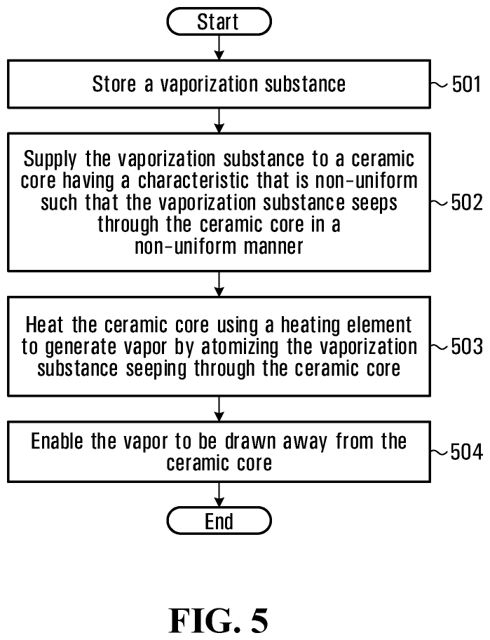

Referring now to FIG. 5, shown is a flowchart of an example method of generating vapor for consumption by a user. This method may be executed with a vaporization apparatus having a ceramic core, for example the vape tank 200 shown in FIG. 2, or any other suitable vaporization apparatus. It is to be understood that the flowchart is very specific and is provided for illustrative purposes only.

In some implementations, as shown at step 501, the vaporization apparatus stores a vaporization substance, for example in a chamber. In some implementations, the chamber has a cylindrical shape that surrounds the ceramic core, and the ceramic core has a cylindrical shape that surrounds an air channel that enables vapor to be drawn away from the ceramic core, as described elsewhere herein, but other geometries are possible. In other implementations, the vaporization apparatus does not store the vaporization substance, and the vaporization substance can be supplied by other means such as manual application by a user for example.

At step 502, the vaporization substance is supplied to the ceramic core. According to an embodiment of the disclosure, the ceramic core has a characteristic, such as density or porosity in some embodiments, that is non-uniform to enable the vaporization substance to seep through the ceramic core in a non-uniform manner. The characteristic of the ceramic core is designed to be non-uniform, with a view to control, to some extent, how the vaporization substance seeps through the ceramic core. Example implementations have been described elsewhere herein and are therefore not repeated here.

In some implementations, the vaporization substance is supplied to the ceramic core via a wick. The wick may help to ensure an even contact between the vaporization substance and the ceramic core as described elsewhere herein. In other implementations, no such wick is used.

At step 503, the vaporization apparatus heats the ceramic core using a heating element to generate vapor from the vaporization substance by atomizing the vaporization substance that seeps through the ceramic core. In some implementations, the heating element is or includes a coil heater embedded in the ceramic core, but other implementations are possible as similarly described elsewhere herein.

Finally, in some implementations, as shown at step 504, the vaporization apparatus enables the vapor to be drawn away from the ceramic core, for example through an air channel.

### Other Methods

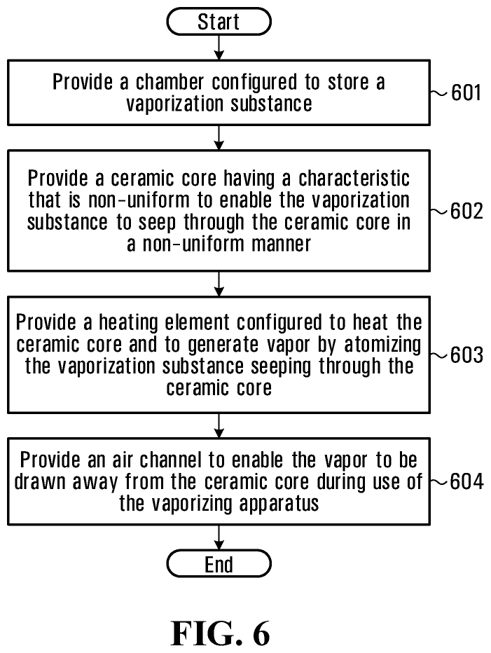

Referring now to FIG. 6, shown is a flowchart of an example method according to another embodiment. This method may be executed by an entity, for example a manufacturer of a vaporization apparatus having a ceramic core such as the vape tank 200 shown in FIG. 2, or any other company, individual, or other entity. It is to be understood that the flowchart is very specific and is provided for illustrative purposes only.

In some implementations, as shown at step 601, a chamber is provided to store a vaporization substance. In some implementations, the chamber has a cylindrical shape that surrounds the ceramic core, and the ceramic core has a cylindrical shape that surrounds an air channel that enables vapor to be drawn away from the ceramic core, as described elsewhere herein, but other geometries are possible. In other implementations, no such chamber is provided for storing the vaporization substance, and the vaporization substance can be supplied by other means such as manual application by a user for example.

At step 602, the ceramic core is provided. According to an embodiment of the disclosure, the ceramic core has a characteristic, such as density or porosity in some embodiments, that is non-uniform to enable the vaporization substance to seep through the ceramic core in a non-uniform manner. The characteristic of the ceramic core is designed to be non-uniform, with a view to control, to some extent, how the vaporization substance seeps through the ceramic core. Example implementations have been described elsewhere herein and are therefore not repeated here.

In some implementations, a wick is provided between the ceramic core and the chamber. The wick may help to ensure an even contact between the vaporization substance and the ceramic core as described elsewhere herein. In other implementations, no such wick is used.

At step 603, a heating element is provided to heat the ceramic core and to generate vapor from the vaporization substance by atomizing the vaporization substance that seeps through the ceramic core. In some implementations, the heating element is or includes a coil heater embedded in the ceramic core, but other implementations are possible as similarly described elsewhere herein.

Finally, in some implementations, as shown at step 604, an air channel is provided to enable the vapor to be drawn away from the ceramic core.

In some implementations, any one or more of a number of other parts for building a vaporization device are provided, such as a power source to provide power to the heating element, and/or a control system to control the power source, and/or a mouthpiece to enable the vapor to be drawn away from the ceramic core. Other implementations are possible.

It should be noted that providing a part or component as referenced in FIG. 6 and described herein does not necessarily involve manufacturing that part or component. For example, a part or component may be provided by purchasing or otherwise acquiring the part or component from a manufacturer, supplier, or distributor. Therefore, an entity may “provide” parts or components in any of various ways, without necessarily manufacturing all, or even any, parts or components.

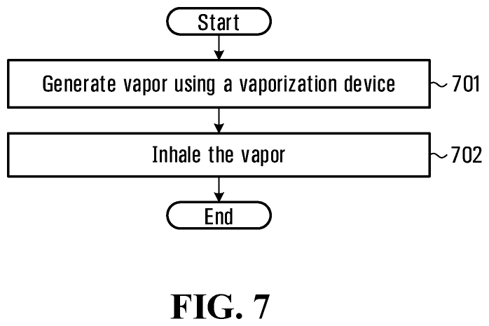

Referring now to FIG. 7, shown is a flowchart of an example method of using a vaporization device. This method may be executed by an entity, for example a user of a vaporization device having a ceramic core as described herein, or some other entity. Step 701 involves generating vapor using the vaporization device, and step 702 involves inhaling the vapor.

### Kit of Parts

According to another embodiment, there is provided a kit of parts. The kit includes parts from which an entity, for example a manufacturer or an end user, may build a vaporization apparatus having a ceramic core, for example the vape tank 200 shown in FIG. 2 or a vaporization device having the vape tank 200.

The kit includes the ceramic core. According to an embodiment of the disclosure, the ceramic core has a characteristic, such as density or porosity in some embodiments, that is non-uniform to enable a vaporization substance to seep through the ceramic core in a non-uniform manner. The characteristic of the ceramic core is designed to be non-uniform, with a view to control, to some extent, how the vaporization substance seeps through the ceramic core. Example implementations have been described elsewhere herein and are therefore not repeated here.

The kit also includes a heating element to heat the ceramic core and to generate vapor by atomizing the vaporization substance seeping through the ceramic core. In some implementations, the heating element is a coil heater embedded in the ceramic core, but other implementations are possible as similarly described elsewhere herein.

In some implementations, the kit also includes a chamber to store the vaporization substance. In some implementations, the chamber has a cylindrical shape that surrounds the ceramic core, and the ceramic core has a cylindrical shape that surrounds an air channel that enables vapor to be drawn away from the ceramic core, as described elsewhere herein, but other geometries are possible. In other implementations, there is no such chamber.

In some implementations, the kit also includes the vaporization substance for the chamber.

In some implementations, the kit also includes a wick to be disposed between the ceramic core and the chamber. The wick may help to ensure an even contact between the vaporization substance and the ceramic core as described elsewhere herein. In other implementations, no such wick is used.

In some implementations, the kit also includes any one or more of a number of other parts for building a vaporization device, such as a power source to provide power to the heating element, and/or a control system for controlling the power source, and/or a mouthpiece to enable the vapor to be drawn away from the ceramic core. Other implementations are possible.

In some implementations, the kit includes instructions for assembling the vaporization apparatus and/or the vaporization device. In other implementations, no such instructions are provided.

### Other Vape Tank

Referring now to FIG. 8, shown is a diagram illustrating another example vape tank 800 with a ceramic core 801. The vape tank 800 can be implemented in a vaporization device, for example the vaporization device 100 shown in FIG. 1, or any other suitable vaporization device. It is to be understood that the vape tank 800 is very specific and is provided for illustrative purposes only.

The vape tank 800 includes a chamber 802, which is coupled to the ceramic core 801, to store a vaporization substance. The ceramic core 801 has a heating element 804 embedded therein and a porosity that enables the vaporization substance to seep through the ceramic core 801, particularly when the vaporization substance has been heated enough by the heating element 804 to reduce its viscosity. During use, the heating element 804 heats up the ceramic core 801 and generates vapor by atomizing the vaporization substance that seeps through the ceramic core 801. The vapor can be drawn through an air channel, as shown at 805. The air channel through which the airflow 805 flows is U-shaped in this example. In some implementations, the heating element 804 is powered by a power source (not shown) and controlled by a control system (not shown). In some implementations, the power source and the control system are disposed in a compartment that physically and electrically connects to the vape tank 800.

According to an embodiment of the disclosure, the porosity of the ceramic core 801 is designed to be non-uniform with a view to control, to some extent, how the vaporization substance seeps through the ceramic core 801. In this manner, it may be possible to mitigate leakage of the vaporization substance out of the vape tank 800.

There are many ways in which the porosity of the ceramic core 801 can be designed to be non-uniform. For example, in some implementations, the porosity of the ceramic core 801 varies and is greatest in regions closest to the air channel as similarly described with reference to FIGS. 3A and 3B. Other implementations are possible. More generally, as similarly described with reference to FIGS. 3A, 3B, 4A and 4B, the porosity of the ceramic core 801 can vary both (1) along a path through which the vaporization substance is to seep through the ceramic core 801, and (2) orthogonally to the path through which the vaporization substance is to seep through the ceramic core 801.

In the case of the ceramic core 801 shown in FIG. 8, a path through which the vaporization substance is to seep through the ceramic core 801 may be non-linear. Hence, in some implementations, porosity of the ceramic core 801 can be designed to vary in a non-linear manner. This could be done for example with a view to achieve an even amount of vaporization substance seeping through the ceramic core 801 on a surface along the air channel 508. Other implementations are possible.

### Vapor & Vaporization Substances

The present disclosure relates, in part, to vaporization apparatuses producing “vapor” by atomizing a vaporization substance. Such “vapor” includes an aerosol in which particles of the vaporization substance are small and light enough to be carried in air. Such particles are produced by atomizing the vaporization substance. Note that atomizing the vaporization substance normally does not involve boiling the vaporization substance to change a state of the vaporization substance from liquid to gas, although some amount of evaporation and/or boiling of the vaporization substance may occur. A user inhales the aerosol, which is commonly referred to as a vapor. In the present disclosure, the term “vapor” is intended to refer to an aerosol in which particles of the vaporization substance are small and light enough to be carried in air.

The present disclosure relates, in part, to vaporization apparatuses for vaporization substances that include active substances such as cannabinoids or nicotine. However, the vaporization apparatuses described herein could also or instead be used for vaporization substances without an active substance. As used herein, the term “cannabinoid” is generally understood to include any chemical compound that acts upon a cannabinoid receptor. Cannabinoids could include endocannabinoids (produced naturally by humans and animals), phytocannabinoids (found in cannabis and some other plants), and synthetic cannabinoids (manufactured artificially).

Examples of phytocannabinoids include, but are not limited to, cannabigerolic acid (CBGA), cannabigerol (CBG), cannabigerol monomethylether (CBGM), cannabigerovarin (CBGV), cannabichromene (CBC), cannabichromevarin (CBCV), cannabidiol (CBD), cannabidiol monomethylether (CBDM), cannabidiol-C4 (CBD-C4), cannabidivarin (CBDV), cannabidiorcol (CBD-C1), delta-9-tetrahydrocannabinol (Δ9-THC), delta-9-tetrahydrocannabinolic acid A (THCA-A), delta-9-tetrahydrocannabionolic acid B (THCA-B), delta-9-tetrahydrocannabinolic acid-C4 (THCA-C4), delta-9-tetrahydrocannabinol-C4, delta-9-tetrahydrocannabivarin (THCV), delta-9-tetrahydrocannabiorcol (THC-C1), delta-7-cis-iso tetrahydrocannabivarin, delta-8-tetrahydrocannabinol (Δ8-THC), cannabicyclol (CBL), cannabicyclovarin (CBLV), cannabielsoin (CBE), cannabinol (CBN), cannabinol methylether (CBNM), cannabinol-C4 (CBN-C4), cannabivarin (CBV), cannabinol-C2 (CBN-C2), cannabiorcol (CBN-C1), cannabinodiol (CBND), cannabinodivarin (CBVD), cannabitriol (CBT), 10-ethoxy-9hydroxy-delta-6a-tetrahydrocannabinol, 8, 9-dihydroxy-delta-6a-tetrahydrocannabinol, cannabitriolvarin (CBTV), ethoxy-cannabitriolvarin (CBTVE), dehydrocannabifuran (DCBF), cannabifuran (CBF), cannabichromanon (CBCN), cannabicitran (CBT), 10-oxo-delta-6a-tetrahydrocannabionol (OTHC), delta-9-cis-tetrahydrocannabinol (cis-THC), 3,4,5,6-tetrahydro-7-hydroxy-alpha-alpha-2-trimethyl-9-n-propyl-2,6-methano-2H-1-benzoxocin-5-methanol (OH-iso-HHCV), cannabiripsol (CBR), trihydroxy-delta-9-tetrahydrocannabinol (triOH-THC), cannabinol propyl variant (CBNV), and derivatives thereof.

Examples of synthetic cannabinoids include, but are not limited to, naphthoylindoles, naphthylmethylindoles, naphthoylpyrroles, naphthylmethylindenes, phenylacetylindoles, cyclohexylphenols, tetramethylcyclopropylindoles, adamantoylindoles, indazole carboxamides, and quinolinyl esters.

A cannabinoid may be in an acid form or a non-acid form, the latter also being referred to as the decarboxylated form since the non-acid form can be generated by decarboxylating the acid form.

A vaporization substance may comprise a cannabinoid in its pure or isolated form or a source material comprising the cannabinoid. Examples of source materials comprising cannabinoids include, but are not limited to, cannabis or hemp plant material (e.g, flowers, seeds, trichomes, and kief), milled cannabis or hemp plant material, extracts obtained from cannabis or hemp plant material (e.g., resins, waxes and concentrates), and distilled extracts or kief. In some embodiments, pure or isolated cannabinoids and/or source materials comprising cannabinoids may be combined with water, lipids, hydrocarbons (e.g., butane), ethanol, acetone, isopropanol, or mixtures thereof.

In some embodiments, the cannabinoid is tetrahydrocannabinol (THC). THC is only psychoactive in its decarboxylated state. The carboxylic acid form (THCA) is non-psychoactive. Delta-9-tetrahydrocannabinol (Δ9-THC) and delta-8-tetrahydrocannabinol (Δ8-THC) produce the effects associated with cannabis by binding to the CB1 cannabinoid receptors in the brain.

In some embodiments, the cannabinoid is cannabidiol (CBD). The terms “cannabidiol” or “CBD” are generally understood to refer to one or more of the following compounds, and, unless a particular other stereoisomer or stereoisomers are specified, includes the compound “Δ2-cannabidiol.” These compounds are: (1) Δ5-cannabidiol (2-(6-isopropenyl-3-methyl-5-cyclohexen-l-yl)-5-pentyl-l,3-benzenediol); (2) Δ4-cannabidiol (2-(6-isopropenyl-3-methyl-4-cyclohexen-l-yl)-5-pentyl-l,3-benzenediol); (3) Δ3-cannabidiol (2-(6-isopropenyl-3-methyl-3-cyclohexen-l-yl)-5-pentyl-l,3-benzenediol); (4) Δ3,7-cannabidiol (2-(6-isopropenyl-3-methylenecyclohex-l-yl)-5-pentyl-l,3-benzenediol); (5) Δ2-cannabidiol (2-(6-isopropenyl-3-methyl-2-cyclohexen-l-yl)-5-pentyl-l,3-benzenediol); (6) Δ1-cannabidiol (2-(6-isopropenyl-3-methyl-l-cyclohexen-l-yl)-5-pentyl-l,3-benzenediol); and (7) Δ6-cannabidiol (2-(6-isopropenyl-3-methyl-6-cyclohexen-l-yl)-5-pentyl-l,3-benzenediol).

In some embodiments, the cannabinoid is a mixture of tetrahydrocannabinol (THC) and cannabidiol (CBD). The w/w ratio of THC to CBD a the vaporization substance may be about 1:1000, about 1:900, about 1:800, about 1:700, about 1:600, about 1:500, about 1:400, about 1:300, about 1:250, about 1:200, about 1:150, about 1:100, about 1:90, about 1:80, about 1:70, about 1:60, about 1:50, about 1:45, about 1:40, about 1:35, about 1:30, about 1:29, about 1:28, about 1:27, about 1:26, about 1:25, about 1:24, about 1:23, about 1:22, about 1:21, about 1:20, about 1:19, about 1:18, about 1:17, about 1:16, about 1:15, about 1:14, about 1:13, about 1:12, about 1:11, about 1:10, about 1:9, about 1:8, about 1:7, about 1:6, about 1:5, about 1:4.5, about 1:4, about 1:3.5, about 1:3, about 1:2.9, about 1:2.8, about 1:2.7, about 1:2.6, about 1:2.5, about 1:2.4, about 1:2.3, about 1:2.2, about 1:2.1, about 1:2, about 1:1.9, about 1:1.8, about 1:1.7, about 1:1.6, about 1:1.5, about 1:1.4, about 1:1.3, about 1:1.2, about 1:1.1, about 1:1, about 1.1:1, about 1.2:1, about 1.3:1, about 1.4:1, about 1.5:1, about 1.6:1, about 1.7:1, about 1.8:1, about 1.9:1, about 2:1, about 2.1:1, about 2.2:1, about 2.3:1, about 2.4:1, about 2.5:1, about 2.6:1, about 2.7:1, about 2.8:1, about 2.9:1, about 3:1, about 3.5:1, about 4:1, about 4.5:1, about 5:1, about 6:1, about 7:1, about 8:1, about 9:1, about 10:1, about 11:1, about 12:1, about 13:1, about 14:1, about 15:1, about 16:1, about 17:1, about 18:1, about 19:1, about 20:1, about 21:1, about 22:1, about 23:1, about 24:1, about 25:1, about 26:1, about 27:1, about 28:1, about 29:1, about 30:1, about 35:1, about 40:1, about 45:1, about 50:1, about 60:1, about 70:1, about 80:1, about 90:1, about 100:1, about 150:1, about 200:1, about 250:1, about 300:1, about 400:1, about 500:1, about 600:1, about 700:1, about 800:1, about 900:1, or about 1000:1.

In some embodiments, a vaporization substance may include products of cannabinoid metabolism, including 11-hydroxy-Δ9-tetrahydrocannabinol (11-OH-THC).

These particulars of cannabinoids are intended solely for illustrative purposes. Other embodiments are also contemplated.

Numerous modifications and variations of the present disclosure are possible in light of the above teachings. It is therefore to be understood that within the scope of the appended claims, the disclosure may be practised otherwise than as specifically described herein.

1. A vaporization apparatus, comprising:
a ceramic core having a characteristic that is non-uniform to enable a vaporization substance to seep through the ceramic core in a non-uniform manner; and
a heating element to heat the ceramic core and generate vapor from the vaporization substance.

2. The vaporization apparatus of claim 1, wherein the heating element comprises a coil heater embedded in the ceramic core.

3-5. (canceled)

6. The vaporization apparatus of claim 1, wherein the characteristic of the ceramic core comprises a physical characteristic of the ceramic core;
wherein the physical characteristic of the ceramic core comprises a porosity of the ceramic core; and
wherein the porosity of the ceramic core varies along, orthogonally to, or both along and orthogonally to a path through which the vaporization substance is to seep through the ceramic core.

7-8. (canceled)

9. The vaporization apparatus of claim 1, wherein the characteristic of the ceramic core comprises a physical characteristic of the ceramic core;
wherein the physical characteristic of the ceramic core comprises a porosity of the ceramic core;
wherein the porosity of the ceramic core varies along a path through which the vaporization substance is to seep through the ceramic core; and
wherein the ceramic core comprises a first ceramic layer and a second ceramic layer coupled to the first ceramic layer, to enable the vaporization substance to seep through the ceramic core via a series combination of the first ceramic layer and the second ceramic layer, and wherein a porosity of the first ceramic layer is different from a porosity of the second ceramic layer.

10. The vaporization apparatus of claim 9, wherein the porosity of the first ceramic layer is greater than the porosity of the second ceramic layer.

11-13. (canceled)

14. The vaporization apparatus of claim 1, wherein the characteristic of the ceramic core comprises a physical characteristic of the ceramic core;
wherein the physical characteristic of the ceramic core comprises a porosity of the ceramic core;
wherein the porosity of the ceramic core varies orthogonally to a path through which the vaporization substance is to seep through the ceramic core; and
wherein the ceramic core comprises a lower ceramic section and an upper ceramic section, to enable the vaporization substance to seep through the ceramic core via a parallel combination of the lower ceramic section and the upper ceramic section, and wherein a porosity of the upper ceramic section is different from a porosity of the lower ceramic section.

15. The vaporization apparatus of claim 14, wherein the porosity of the upper ceramic section is greater than the porosity of the lower ceramic section.

16-20. (canceled)

21. A method comprising:
supplying a vaporization substance to a ceramic core having a characteristic that is non-uniform, to enable the vaporization substance to seep through the ceramic core in a non-uniform manner;
heating the ceramic core using a heating element to generate vapor from the vaporization substance.

22-25. (canceled)

26. The method of claim 21, wherein the characteristic of the ceramic core comprises a physical characteristic of the ceramic core;
wherein the physical characteristic of the ceramic core comprises a porosity of the ceramic core; and
wherein the porosity of the ceramic core varies along, orthogonally to, or both along and orthogonally to a path through which the vaporization substance is to seep through the ceramic core.

27-28. (canceled)

29. The method of claim 21, wherein the characteristic of the ceramic core comprises a physical characteristic of the ceramic core;
wherein the physical characteristic of the ceramic core comprises a porosity of the ceramic core;
wherein the porosity of the ceramic core varies along a path through which the vaporization substance is to seep through the ceramic core; and
wherein the ceramic core comprises a first ceramic layer and a second ceramic layer coupled to the first ceramic layer, to enable the vaporization substance to seep through the ceramic core via a series combination of the first ceramic layer and the second ceramic layer, and wherein a porosity of the first ceramic layer is different from a porosity of the second ceramic layer.

30. The method of claim 29, wherein the porosity of the first ceramic layer is greater than the porosity of the second ceramic layer.

31-33. (canceled)

34. The method of claim 21, wherein the characteristic of the ceramic core comprises a physical characteristic of the ceramic core;
wherein the physical characteristic of the ceramic core comprises a porosity of the ceramic core;
wherein the porosity of the ceramic core varies orthogonally to a path through which the vaporization substance is to seep through the ceramic core; and
wherein the ceramic core comprises a lower ceramic section and an upper ceramic section, to enable the vaporization substance to seep through the ceramic core via a parallel combination of the lower ceramic section and the upper ceramic section, and wherein a porosity of the upper ceramic section is different from a porosity of the lower ceramic section.

35. The method of claim 34, wherein the porosity of the upper ceramic section is greater than the porosity of the lower ceramic section.

36-61. (canceled)

62. A method, comprising:
providing a ceramic core having a characteristic that is non-uniform to enable a vaporization substance to seep through the ceramic core in a non-uniform manner; and
providing a heating element to heat the ceramic core and generate vapor from the vaporization substance.

63-67. (canceled)

68. The method of claim 62, wherein the characteristic of the ceramic core comprises a physical characteristic of the ceramic core;
wherein the physical characteristic of the ceramic core comprises a porosity of the ceramic core; and
wherein the porosity of the ceramic core varies along, orthogonally to, or both along and orthogonally to a path through which the vaporization substance is to seep through the ceramic core.

69-70. (canceled)

71. The method of claim 62, wherein the characteristic of the ceramic core comprises a physical characteristic of the ceramic core;
wherein the physical characteristic of the ceramic core comprises a porosity of the ceramic core;
wherein the porosity of the ceramic core varies along a path through which the vaporization substance is to seep through the ceramic core; and
wherein the ceramic core comprises a first ceramic layer and a second ceramic layer coupled to the first ceramic layer, to enable the vaporization substance to seep through the ceramic core via a series combination of the first ceramic layer and the second ceramic layer, and wherein a porosity of the first ceramic layer is different from a porosity of the second ceramic layer.

72. The method of claim 71, wherein the porosity of the first ceramic layer is greater than the porosity of the second ceramic layer.

73-75. (canceled)

76. The method of claim 62, wherein the characteristic of the ceramic core comprises a physical characteristic of the ceramic core;
wherein the physical characteristic of the ceramic core comprises a porosity of the ceramic core;
wherein the porosity of the ceramic core varies orthogonally to a path through which the vaporization substance is to seep through the ceramic core; and
wherein the ceramic core comprises a lower ceramic section and an upper ceramic section, to enable the vaporization substance to seep through the ceramic core via a parallel combination of the lower ceramic section and the upper ceramic section, and wherein a porosity of the upper ceramic section is different from a porosity of the lower ceramic section.

77. The method of claim 76, wherein the porosity of the upper ceramic section is greater than the porosity of the lower ceramic section.

78-82. (canceled)

83. A method comprising:
generating vapor using a vaporization device comprising a vaporization apparatus according to claim 1; and
inhaling the vapor.
